(19) United States
(12) Patent Application Publication
(10) Pub. No.: US 2014/0137712 A1
(43) Pub. Date: May 22, 2014

(54) LATHE CENTER

(71) Applicant: GENERAL ELECTRIC COMPANY, Schenectady, NY (US)

(72) Inventors: Thomas Joseph Farineau, Schenectady, NY (US); Manuel Julio Gomez Fernandez, Warsaw (PL); David Robert Schumacher, Scotia, NY (US)

(73) Assignee: GENERAL ELECTRIC COMPANY, Schenectady, NY (US)

(21) Appl. No.: 13/682,219

(22) Filed: Nov. 20, 2012

(51) Int. Cl. B23B 23/04

(52) U.S. Cl. CPC B23B 23/04
USPC 82/170

(57) ABSTRACT

A lathe center can include a boss formed in a cavity of a work end of a work piece, such as a shaft. The boss has a height as measured from an end wall of the cavity. A support recess can be formed in the boss, and by limiting a depth of the support recess to no more than the height of the boss, stress and strain around the cavity during startup and/or operation of the work piece and/or an assembly including the work piece can be reduced.

### BACKGROUND OF THE INVENTION

The disclosure relates generally to machining, and more particularly to lathe centers used in the manufacture and/or assembly of rotating machinery, such as turbine rotors.

A rotor assembly can include a number of cylindrical and/or conical and/or annular parts that are typically formed by machining with a lathe or the like. During machining, such parts are generally secured using lathe centers, which are typically formed in weld cavities in the ends of parts being machined. Once the parts are machined, they can be welded together to form a rotor assembly, leaving a weld cavity in the assembly including a weld cavity from each welded part. Typically, each lathe center is formed in a vertical wall of the weld cavity, but this can introduce stress and/or strain in the assembly during operation and/or startup.

### BRIEF DESCRIPTION OF THE INVENTION

Embodiments of the invention disclosed herein may take the form of a lathe center in which a boss can project from an end wall of a cavity in a work end of a work piece. At least one support recess can be formed in the boss, and a boss height of the boss as measured from the end wall can be at least equal to a depth of a deepest support recess.

Another embodiment may include a lathe center that can include a cavity formed in a work end of a work piece. A boss can project from an end wall at a deepest portion of the cavity. At least one support recess in the boss can penetrate into the boss, none of the at least one support recess penetrating further than the end wall.

A further embodiment can include a work piece, a work end of the work piece, and a substantially cylindrical cavity in the work end. The cavity can have an end wall, and a substantially cylindrical boss can project from the end wall into the cavity. The boss can be made from a material, and a height of the boss can be based on at least one of a property of the material or an expected load to be applied to the lathe center. In addition, at least one support recess can be formed in the boss with a respective support recess depth. A deepest support recess of the at least one support recess can have a respective support recess depth no greater than the boss height.

Other aspects of the invention provide methods of making embodiments of the invention disclosed herein, as well as variants of the apparatus, which include and/or implement some or all of the actions and/or features described herein. The illustrative aspects of the invention are designed to solve one or more of the problems herein described and/or one or more other problems not discussed.

### BRIEF DESCRIPTION OF THE DRAWING

These and other features of the disclosure will be more readily understood from the following detailed description of the various aspects of the invention taken in conjunction with the accompanying drawings that depict various aspects of the invention.

FIG. 1 shows a schematic cross sectional diagram of a first example of a lathe center formed within a work piece according to embodiments of the invention disclosed herein.

FIG. 2 shows a schematic cross sectional diagram of a second example of a lathe center formed within a work piece according to embodiments of the invention disclosed herein.

FIG. 3 shows a schematic cross sectional diagram of a welded rotor assembly in which two lathe centers according to embodiments of the invention disclosed herein are used.

FIG. 4 shows a schematic perspective sectioned diagram of an assembly which can be formed from work pieces using lathe centers according to embodiments of the invention disclosed herein.

It is noted that the drawings may not be to scale. The drawings are intended to depict only typical aspects of the invention, and therefore should not be considered as limiting the scope of the invention. In the drawings, like numbering represents like elements between the drawings.

The detailed description explains embodiments of the invention, together with advantages and features, by way of example with reference to the drawings.

### DETAILED DESCRIPTION OF THE INVENTION

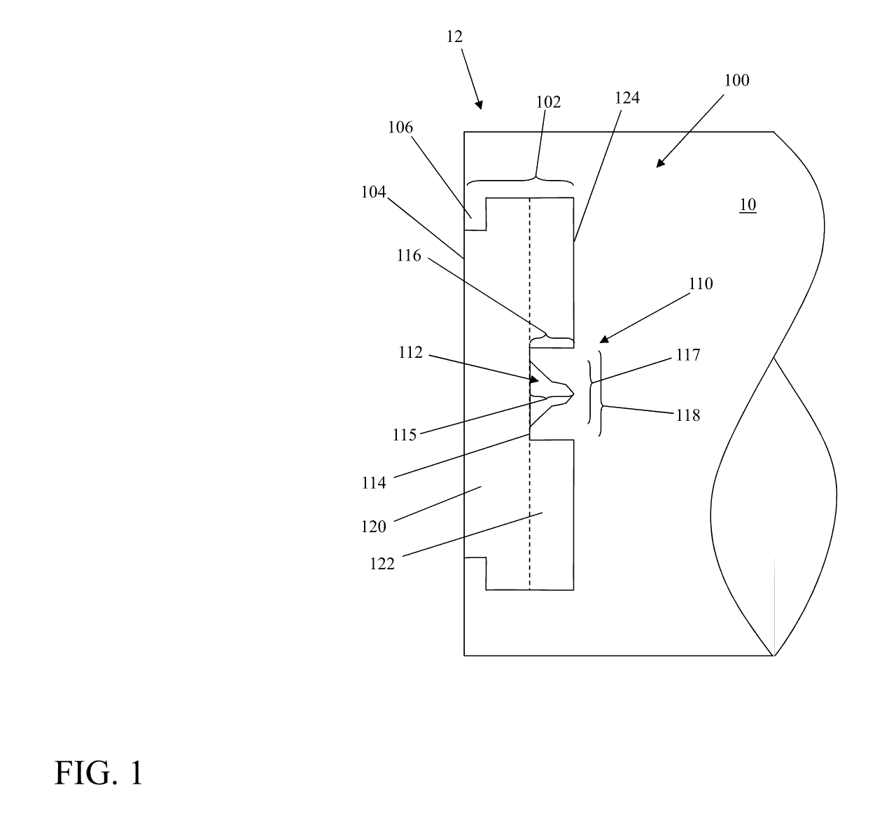

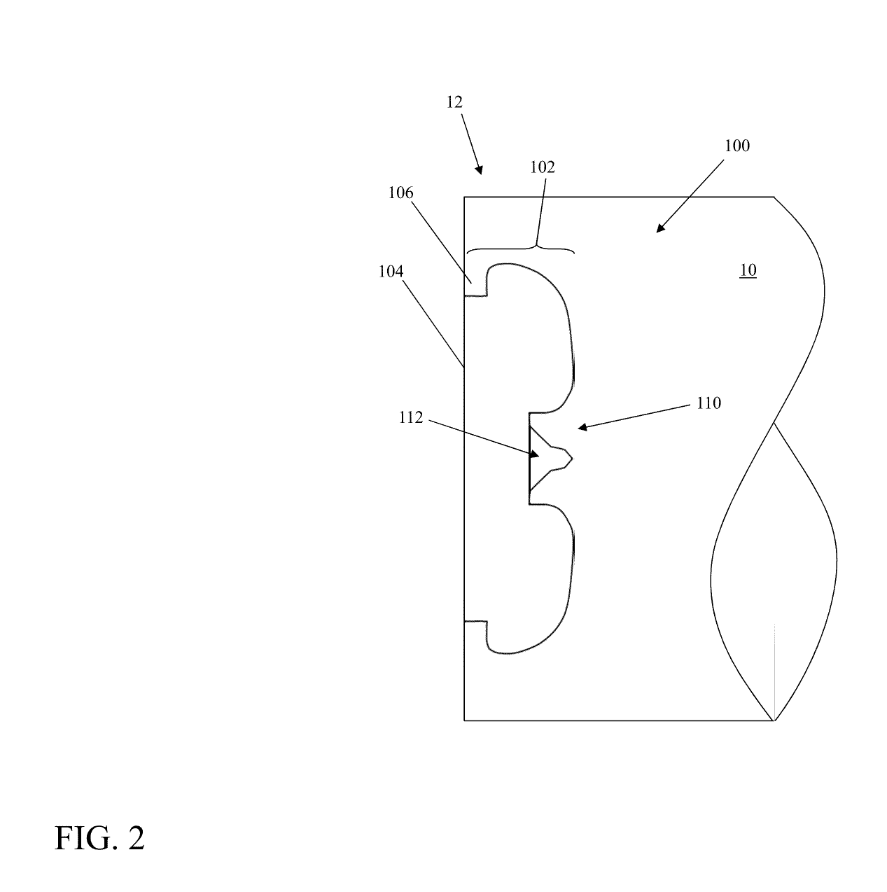

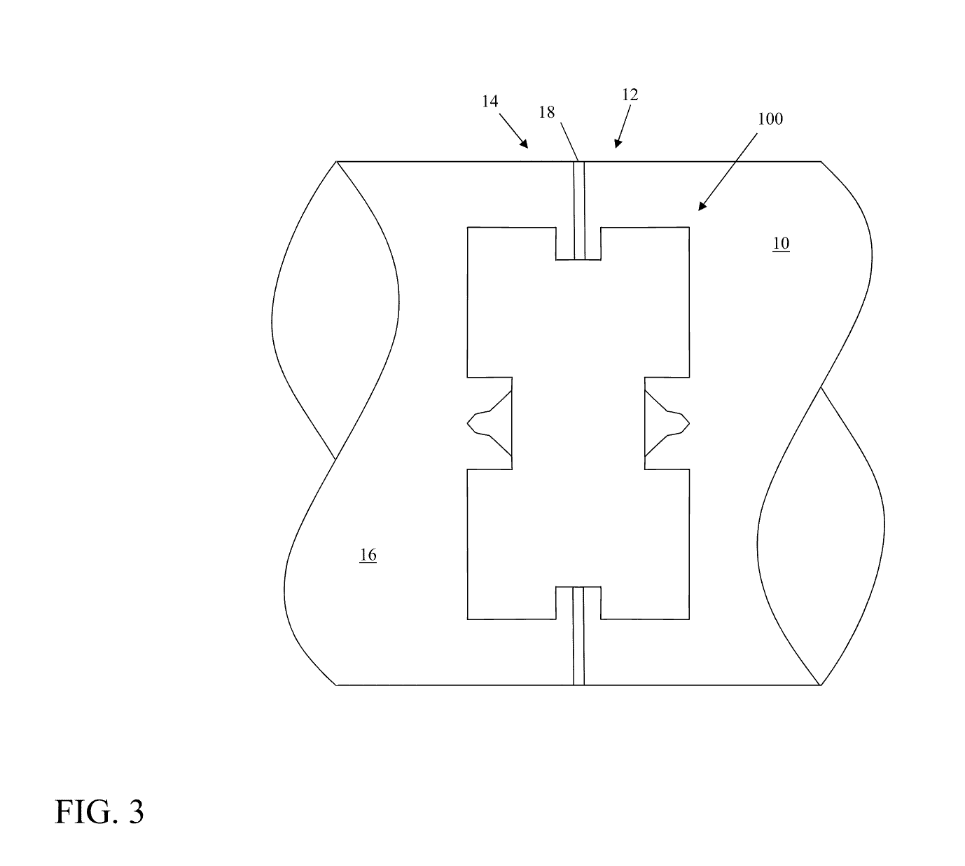

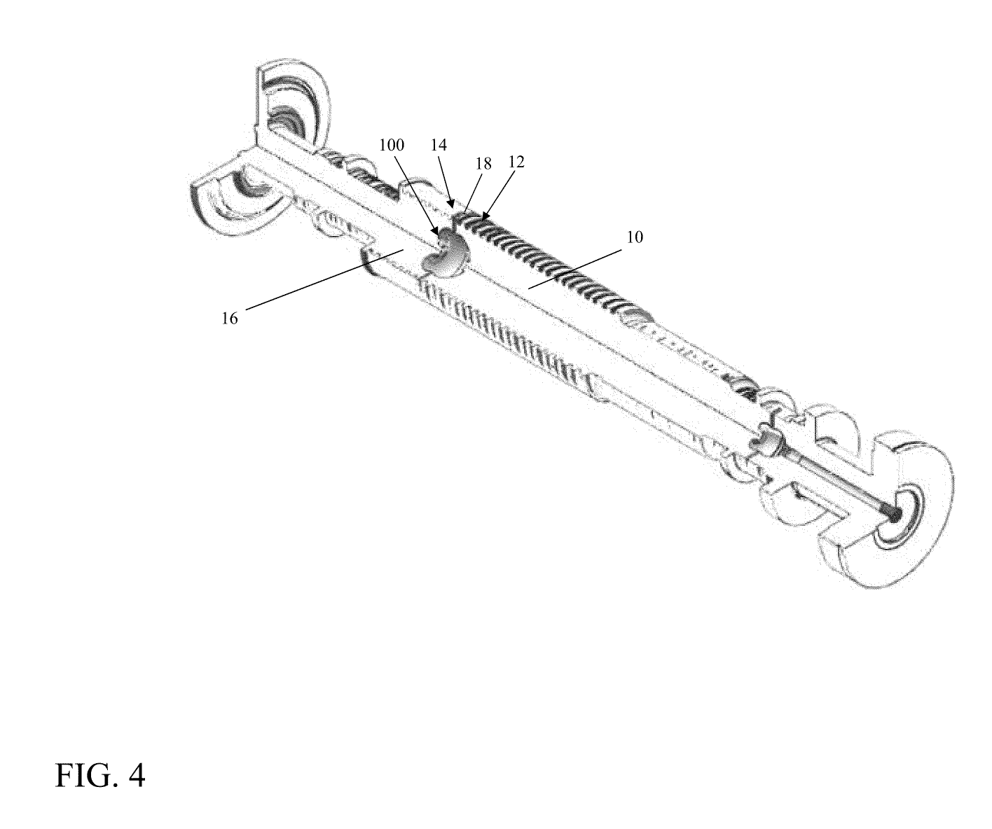

With reference to FIG. 1, a work piece 10, such as a rotatable body or a shaft, can include a lathe center 100 in a work end 12 of work piece 10. Lathe center 100 can include a boss 110 extending from a rear of a cavity 102, such as a weld cavity, formed in work piece 10 toward an opening 104 in work end 12. Support recesses 112 can be included in boss 110 so that lathe work tips or the like can be received, allowing work piece 10 to be turned on a lathe or otherwise manipulated. In embodiments, cavity 102 can include a lip 106 at opening 104, and reentrant corners of cavity 102 can be rounded to further reduce stress and/or strain as seen in FIG. 2. As further seen in FIGS. 3 and 4, a second work end 14 of a second work piece 16 can be arranged to abut work end 12 of work piece 10 so that work pieces 10, 16 can be joined, such as by welding, which can leave a weld seam 18 or the like therebetween. The joined work pieces 10, 16 in embodiments can form a welded rotor segment, though other assemblies can be formed using embodiments of the inventive lathe center 100.

Turning again to FIG. 1, cavity 102 can be construed as including a substantially cylindrical cavity 120 extending from opening 104 to an end surface 114 of boss 110. In addition, cavity 102 can be construed as including a substantially annular cavity 122 extending from end surface 114 to a substantially annular end wall 124 of cavity 102, substantially defining boss 110.

With continued reference to FIG. 1, boss 110 can project from end wall 124 toward opening 104 of work end 102 of work piece 10. As indicated above, one or more support recesses 112 can be formed in boss 110 to accommodate lathe work tips or the like (not shown). Support recess(es) 112 can be formed to extend from end surface 114 of boss 110 to a support recess depth 115. In embodiments, stress and/or strain can be reduced around a location of lathe center 100 by limiting support recess depth 115 to a defined depth, such as no further than end wall 124 of cavity 102. This can also be expressed as ensuring that boss height 116 is at least as high as support recess depth 115. In embodiments, support recess depth 115 can be limited to no more than a determined percentage of a boss height 116, boss height 116 being measured from end wall 124, where “no further than end wall 124” would be substantially 100% of boss height 116. This can also be express as ensuring that boss height 116 exceeds support recess depth 115 by a determined percentage. The particular limitation on boss height 116 and/or support recess depth 115 can be determined according to an expected load to be applied through lathe center 100, a property of a material from which lathe center 100, boss 110, work piece 10, and/or other parts are made, and/or other factors as may be desired and/or appropriate.

Additional stress and/or strain reductions can be achieved by limiting a support recess width 117 of a widest support recess of support recess(es) 112 relative to a boss width 118. The particular limitation on support recess width 117 in embodiments can be determined based on an expected load to be applied to lathe center 100, a material property of material used to make lathe center 100, boss 110, work piece 10, and/or lathe work tips (not shown) to be used with lathe center 100, and/or any other factors as may be suitable and/or appropriate. In embodiments, support recess width 117 can be limited to no more than a determined percentage of boss width 118 as may be appropriate and/or desired. Where boss 110 and/or support recess(es) 112 have substantially circular cross sections as taken transverse to an axis of rotation of work piece 10, the respective widths 117, 118 are respective diameters of boss 110 and/or support recess(es) 112. It should be noted that the percentages used as examples in this description are not limiting, and that any percentages can be used as may be appropriate and/or desired. In addition, it should be recognized that lathe center 100 need not be limited in use to only shafts and/or only work pieces that are to be welded together. Rather, lathe center 100 can be employed in any work piece that would be machined in a lathe or the like.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A lathe center comprising:
a boss projecting from an end wall of a cavity in a work end of a work piece; and
at least one support recess formed in the boss, a boss height of the boss as measured from the end wall being at least equal to a support recess depth of a deepest support recess.

2. The lathe center of claim 1, wherein the boss height is based at least in part on an expected load of the lathe center.

3. The lather center of claim 1, wherein the boss is made from a material and the boss height is based at least in part on a property of the material.

4. The lathe center of claim 1, wherein a support recess width of a widest support recess is no more than a boss width of the boss.

5. The lathe center of claim 4, wherein the boss width is based at least in part on an expected load of the lathe center.

6. The lathe center of claim 4, wherein the boss is made from a material and the boss width is based at least in part on a property of the material.

7. The lathe center of claim 4, wherein the support recess width is based at least in part on an expected load of the lathe center.

8. The lathe center of claim 4, wherein the boss is made from a material and the support recess width is based at least in part on a property of the material.

9. The lathe center of claim 1, wherein the cavity is substantially cylindrical, the boss is substantially cylindrical, and the boss is substantially coaxial with the cavity along an axis of rotation of the work piece.

10. A lathe center comprising:
a cavity formed in a work end of a work piece, the cavity including an end wall at a deepest portion of the cavity;
a boss projecting from the end wall; and
at least one support recess in the boss, none of the at least one support recess penetrating into the boss farther than the end wall.

11. The lathe center of claim 10, wherein the cavity includes a substantially annular cavity around the boss and a substantially cylindrical cavity between the boss and the work end of the work piece, and the boss is substantially cylindrical and coaxial with the cavity along an axis of rotation of the work piece.

12. The lathe center of claim 10, wherein the boss is substantially cylindrical, the at least one support recess has a substantially circular cross section taken transverse to an axis of rotation of the work piece, and the boss and the at least one support recess are coaxial along the axis of rotation.

13. The lathe center of claim 10, wherein a support recess width of a widest support recess is no more than a boss width of the boss.

14. The lathe center of claim 13, wherein the support recess width is based at least in part on an expected load of the lathe center.

15. The lathe center of claim 13, wherein the support recess width is based at least in part on a property of a material from which the boss is made.

16. The lathe center of claim 10, wherein a height of the boss measured from the end wall is based at least in part on an expected load of the lathe center.

17. The lathe center of claim 10, wherein the boss is made from a material and a height of the boss measured from the end wall is based at least in part on a property of the material.

18. The lathe center of claim 10, wherein a depth of penetration of the at least one support recess is based at least in part on an expected load of the lathe center.

19. The lathe center of claim 10, wherein the boss is made from a material and a depth of penetration of the at least one support recess is based at least in part on a property of the material.

20. A lathe center comprising:
a work piece;
a work end of the work piece;
a substantially cylindrical cavity formed in the work end and including an end wall;
a substantially cylindrical boss made from a material and projecting from the end wall into the cavity, the boss having a boss height based on at least one of a property of the material or an expected load to be applied to the lathe center; and
at least one support recess in the boss with a respective support recess depth, a deepest support recess of the at least one support recess having a respective support recess depth no greater than the boss height.
